(19) United States
(12) Patent Application Publication
(10) Pub. No.: US 2004/0141889 A1
(43) Pub. Date: Jul. 22, 2004

(54) Catalytic converter comprising inner heat shield with noise suppression

(75) Inventors: Hang Li, Farmington Hills, MI (US); William R. Koivula, Milford, MI (US); Joseph Michael Lanzesira, Monroe, MI (US); Xiaoming Bian, Farmington Hills, MI (US)

Correspondence Address: VISTEON, C/O BRINKS HOFER GILSON & LIONE, PO BOX 10395, CHICAGO, IL, 60610, US

(73) Assignee: Visteon Global Technologies, Inc.

(21) Appl. No.: 10/345,502

(22) Filed: Jan. 16, 2003

(51) Int. Cl. B01D 53/34

(52) U.S. Cl. 422/180; 422/177; 422/179

(57) ABSTRACT

A catalytic converter for an automotive exhaust system or the like comprises a catalyst substrate within a midsection of a metal housing. The metal housing includes an end section that extends from the midsection and includes an opening, which may be either an inlet or an outlet for the catalytic converter. An inner heat shield is disposed within the end section and includes a flared section that is spaced apart from the housing end section to provide thermal insulation. The flared section is formed of a metal sheet and includes one or more ribs to reinforce the flared section and reduce vibration that might otherwise produce noise. Preferably, the ribs are formed by elongated ridges that extend generally in the direction of gas flow through the converter.

### TECHNICAL FIELD OF THE INVENTION

This invention relates to a catalytic converter comprising a metal housing having an end section, which may be an inlet or an outlet, and a heat shield disposed within the end section. More particularly, this invention relates to such catalytic converter wherein the heat shield includes a flared section that is reinforced with one or more ribs to reduce noise.

### BACKGROUND OF THE INVENTION

Automotive vehicles are equipped with a catalytic converter for treating exhaust gases to reduce noxious compounds prior to emission into the atmosphere. A typical catalytic converter comprises a catalyst substrate that is formed of a ceramic material and defines a plurality of gas passages coated with a catalytic agent. The catalyst substrate is enclosed within a metal housing that includes end sections that are connected to exhaust pipes and provide an inlet and outlet for the converter. During operation, exhaust gases enter the converter through the inlet, flow through the gas passages of the catalyst substrate for treatment, and exit through the outlet.

U.S. patent application Ser. No. 10/282,675 (Attorney Docket No. 10541-545) describes a catalytic converter that includes an inner heat shield within the end section spaced apart from the housing to thermally insulate the housing from the heat of the exhaust gases. The heat shield is attached to the housing at the opening, which may be either the inlet or the outlet, and includes a frustoconical section having an enlarged open end disposed about the catalyst substrate. Clearance is preferably provided between the inner heat shield and the catalyst substrate to prevent damage to the fragile substrate due to differential thermal expansion of the ceramic and the metal. As a result, the open end of the heat shield is free to vibrate and produces audible noise that is noticeable, including to passengers of the vehicle. A ceramic fiber mating or other material may be included in the space between the heat shield and the housing to enhance thermal insulation and provides an additional advantage in reducing noise. However, this adds to the material and manufacturing costs and is not desired.

Therefore, a need exits for a catalytic converter having an inner heat shield that is disposed within an end section of a metal housing and reduces noise caused by vibration of the heat shield during operation, without requiring additional material or manufacturing steps.

### BRIEF SUMMARY OF THE INVENTION

In accordance with the preferred embodiment of this invention, a catalytic converter is provided for an automotive exhaust system or the like. The catalytic converter comprises a catalyst substrate within a midsection of a metal housing. The housing includes an end section that extends from the midsection adjacent one end of the catalyst substrate and includes an opening spaced apart from the substrate end, which may form either an inlet or an outlet to the catalytic converter. An inner heat shield is disposed within the end section and includes a flared section spaced apart from the housing end section for providing thermal insulation. The flared section includes an enlarged open end about the substrate and communicates with the housing opening to define a gas flow passage. The flared section is formed of a metal sheet and includes one or more ribs generally in the direction of the gas flow. The ribs reinforce the flared section to increase the vibration resonance frequency, which in turn effectively reduces lower frequency vibration during use and reduces noise.

### BRIEF DESCRIPTION OF THE DRAWINGS

The present invention will be further illustrated with reference to the accompanying drawings wherein:

FIG. 1 is a cross-sectional view of a catalytic converter in accordance with a preferred embodiment of this invention;

FIG. 2 is a cross-sectional view of the catalytic converter in FIG. 1 taken along line 2-2 in the direction of the arrows; and

FIG. 3 is a plan view of the heat shield in the catalytic converter in FIG. 1.

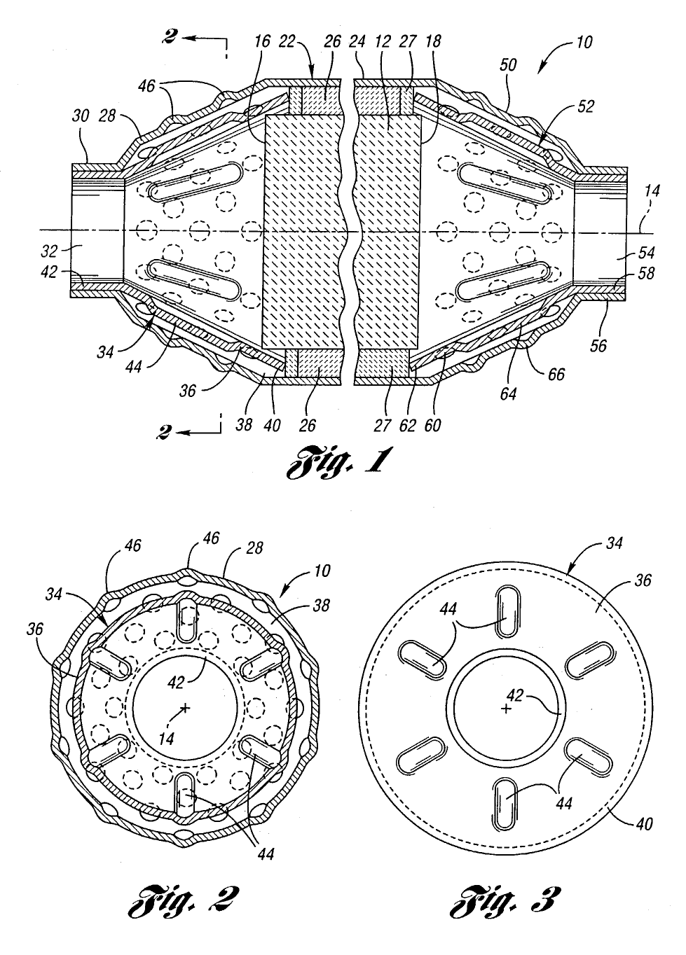

### DETAILED DESCRIPTION OF THE INVENTION

In accordance with a preferred embodiment of this invention, referring to the Figures, catalytic converter 10 is adapted for use in an exhaust system of an automotive vehicle for treating exhaust gases prior to emission into the atmosphere. Converter 10 comprises a catalyst substrate 12 having an outer surface symmetrical about a longitudinal axis 14. Substrate 12 comprises an inlet end 16, an outlet end 18 and a plurality of gas passages (not shown) extending axially therebetween. A preferred substrate shape is a rectangular cylinder having a circular cross section. Alternately, the substrate may suitably have an oval or other cross section. Substrate 12 is preferably formed of a ceramic or a metallic material and includes a catalyst coating containing a catalyst agent applied to surfaces of the gas passages for treating exhaust gases that flow therethrough.

Substrate 12 is enclosed within a metal housing 22. In a preferred embodiment, housing 22 comprises stamped sheet metal sections joined by welding, such as half-sections joined by a perimeter weld bead (not shown). Housing 22 comprises a midsection 24 circumferentially about substrate 12 and symmetrical about axis 14. A thermally insulative mat 26 formed of ceramic fibrous material and seals 27 are interposed between midsection 24 and substrate 12.

Metal housing 22 also includes an end section 28, which constitutes an inlet end in the described embodiment. Inlet end section 28 extends axially from midsection 24 adjacent substrate inlet end 16 and includes an inlet 32 spaced apart from the substrate end 16. Opening 32 is surrounded by a rim 30 adapted for connection to an exhaust pipe of the automotive exhaust system. In accordance with this invention, converter 10 further comprises an inner heat shield 34 disposed within an end section 28. Inner heat shield 34 is formed of metal sheet and includes a flared section 36. Flared section 36 has a frustoconical shape symmetrical about axis 14 and is radially spaced from housing end section 28 by a space 38. Space 38 thermally insulates metal housing 22 from the heat of exhaust gases that flow through heat shield 34 during operation. While it is an advantage of the described embodiment to use gas in space 38 as a thermal barrier and reduce material cost, a ceramic fiber mat or other suitable insulative material may be included in space 38 to provide additional thermal and noise insulation.

Heat shield 34 includes an enlarged open end 40 that extends circumferentially about substrate 12, such that inlet end 16 is received within flared section 36. Heat shield 34 includes a band 42 affixed to rim 30 of end section 28 and cooperating therewith in defining inlet 32 to the catalytic converter. At end 40, clearance is provided between heat shield 34 and substrate 12 to avoid stresses that might otherwise occur due to differential thermal expansion of the metal and the ceramic during heating and cooling experienced by the catalytic converter during use. As a result, flared section 36 is free to vibrate, which would produce noise. In accordance with this invention, longitudinal ribs 44 are provided in flared section 36. Ribs 44 are preferably ridges that are elongated in a direction of gas flow through the flared section, which is generally along axis 14. In a preferred embodiment, heat shield 34 is formed from a metal sheet by a metal drawing operation, with ridges 44 being formed concurrently with flared section 36 in a single operation. In a preferred embodiment shown in the Figs., ribs 44 are disposed equidistantly about the circumference of the flared section. However, the ribs may be suitably located in a nonsymmetrical or other strategic arrangement to optimize noise reduction for a converter of a particular design and materials. Ridges 44 preferably protrude radially outwardly about the flared section. Alternatively, the ribs may be formed of ridges that protrude inwardly, or may be formed of metal strips affixed to the inner or outer surface of the flared section. It is found that ridges 44 stiffen flared section 36 to inhibit vibration and thereby reduce noise.

Dimples 46 are provided in end section 28 to further reduce noise caused by vibration of the outer metal housing. Alternately, end section 28 may include ribs similar to ribs 44 for reducing vibration of the metal.

In accordance with the preferred embodiment, catalytic converter 10 includes an outlet end section 50 of metal housing 22 and an inner heat shield 52 that cooperate to define the outlet 54 for the catalytic converter and are substantially similar in construction to the inlet end section 28 and inner heat shield 34. Accordingly, end section 50 extends from midsection 24 of metal housing 22 adjacent outlet end 18 of catalyst substrate 12 and includes a rim 56 about outlet 54. Inner heat shield 52 includes a band 58 affixed to rim 56 at outlet 54 and a flared section 60 spaced apart from end section 50 to provide thermal insulation of the metal housing from the heat of exhaust gases flowing through inner heat shield 52. Flared section 60 has an enlarged open end 62 that extends about catalyst substrate 12 with clearance to prevent damage due to differential thermal expansion of the ceramic and of the metal during heating and cooling cycles. In accordance with this invention, flared section 60 includes a plurality of elongated ribs 64. Ribs 64 are preferably ridges formed in the sheet metal and extend along the direction of gas flow through the inner heat shield. The ribs stiffen the heat shield to reduce vibration that would otherwise produce noise. Also, dimples 66 are provided in end section 50 to further suppress noise.

During operation, catalytic converter 10 is incorporated into an exhaust system of an automotive vehicle with inlet 32 coupled to an exhaust pipe leading from an exhaust manifold of an internal combustion engine and outlet 54 coupled to an exhaust pipe through which exhaust gases are emitted into the atmosphere. During engine operation, exhaust gases are admitted to the catalytic converter through inlet 32 and are directed by heat shield 34 to the inlet end 16 of catalyst substrate 12. The exhaust gases flow through the gas passages in catalyst substrate 12 and are treated by the catalytic agent before being emitted from outlet end 18. At outlet end 18, the treated gases are directed by inner heat shield 60 to outlet 54. The inner heat shields 34 and 52 thermally insulate the metal housing 22 from the elevated temperature of the exhaust gases flowing through the catalytic converter. Because of the clearance provided between open end 40 of heat shield 34 and open end 62 of heat shield 52, the flow of exhaust gases tends to cause flared sections 36 and 60 to vibrate. The stiffening ribs 44 and 64 reinforce flared sections 36 and 60 and inhibit the vibration thereof, thereby reducing noise emanating from the converter. Noise is further reduced by dimples 46 and 66 in the end sections 28 and 50 of metal housing 22.

In the described embodiment, the catalytic converter comprises an inlet 32 and an outlet 54 that are aligned and symmetrical about axis 14, along with substrate 12 and housing midsection 24. Alternately, the inlet or outlet or both may have a central axis that is oblique to or offset from the substrate axis. Also, rib-reinforced heat shields in accordance with this invention may be used in a catalytic converter comprising a seamless metal housing formed from a metal tube by a spin-forming process, such as described in U.S. patent application Ser. No. 10/282,675, filed Oct. 29, 2002 incorporated herein by reference.

Therefore, this invention provides a catalytic converter having an inner heat shield within the outlet or the inlet end sections or both to reduce the temperature of the outer metal housing. The end section includes stiffening ribs that inhibit vibration of the flared section to reduce noise caused by exhaust gases flowing therethrough. It is an advantage of the preferred embodiment that the stiffening ribs are effective in reducing noise without requiring additional material that would add to the cost of the catalytic converter, although this invention may be practiced with additional insulative material provided about the heat shield to further reduce the noise. Furthermore, the stiffening ribs in the preferred embodiment are ridges formed in the sheet metal of the inner heat shield and thus are readily produced during the manufacture of the inner heat shield without requiring additional processing steps.

While this invention has been described in terms of certain embodiments thereof, it is not intended to be limited to the described embodiments, but only to the extent sent forth in the claims that follow.

1 A catalytic converter comprising:
a catalyst substrate having a substrate end;
a metal housing having a midsection about the catalyst substrate and an end section extending from the midsection, said end section including a housing opening spaced apart from the substrate end; and
an inner heat shield disposed within the end section, said inner heat shield comprising a flared section spaced apart from the end section, said flared section having an enlarged open end adjacent the substrate end and communicating with the housing opening to define a gas flow path between said housing opening and said substrate end, said flared section being formed of a metal sheet and comprising an at least one rib for reinforcing the flared section to reduce vibration thereof.

2. A catalytic converter according to claim 1, wherein the rib comprises an elongated ridge formed in the metal sheet.

3. A catalytic converter according to claim 1, wherein the flared section comprises a plurality of ribs spaced equidistant spaced about the flared section.

4. A catalytic converter according to claim 1, wherein the housing end section of the metal housing includes ribs.

5. A catalytic converter according to claim 1, wherein the housing end section of the metal housing includes dimples.

6. A catalytic converter according to claim 1, wherein the enlarged open end of the flared section is spaced apart from the substrate.

7. A catalytic converter according to claim 1, wherein the housing opening provides an inlet for admitting exhaust gas to the catalytic converter.

8. A catalytic converter according to claim 1, wherein the housing opening provides an outlet for expelling exhaust gas from the converter.

9. A catalytic converter according to claim 1, wherein the inner heat shield comprises a band affixed to the housing opening.

10. A catalytic converter according to claim 1, wherein the catalyst substrate is formed of a ceramic or metallic material and includes a plurality of gas passages having a catalyst agent applied thereto.

11. A catalytic converter for an automotive vehicle for treating exhaust gases, said catalytic converter comprising:
a catalyst substrate having a substrate inlet end and a substrate outlet end;
a metal housing having a midsection about the catalyst substrate, an inlet end section extending from the midsection adjacent the substrate inlet end and including an inlet opening, and an outlet end section extending from the midsection adjacent the substrate outlet end and including an outlet opening;
a first inner heat shield disposed within the inlet end section affixed to the inlet end section adjacent the inlet opening, said first inner heat shield comprising a flared section spaced apart from the inlet end section and having an enlarged open end adjacent the substrate end spaced apart therefrom, said flared section being formed of a metal sheet and comprising a plurality of ribs extending generally in the direction of the gas flow through the flared section; and
a second inner heat shield disposed within the outlet end section and affixed to the outlet end section adjacent the outlet opening, said second inner heat shield comprising a flared section spaced apart from the outlet end section and having an enlarged open end adjacent the substrate outlet end spaced apart therefrom, said flared section being formed of a metal sheet and comprising a plurality of ribs extending generally in the direction of gas flow.

12. A catalytic converter according to claim 11, wherein the ribs comprise elongated ridges.

13. A catalytic converter according to claim 12, wherein the ridges protrude outwardly about the flared section.

14. A catalytic converter according to claim 11, wherein the ribs are spaced equidistantly about the flared section.

15. A catalytic converter according to claim 11, wherein the inlet end section and the outlet end section include dimples.

16. A catalytic converter according to claim 11 wherein the catalyst substrate is formed of a ceramic or metallic material and includes a plurality of gas passages having a catalyst agent applied thereto.

17. A catalytic converter according to claim 11 wherein the metal housing comprises stamped sheet metal sections joined by welding.

18. A catalytic converter according to claim 11 wherein the metal housing is a seamless metal housing formed by a spin-forming process.
